(19) United States
(12) Patent Application Publication
(10) Pub. No.: US 2013/0260076 A1
(43) Pub. Date: Oct. 3, 2013

(54) Separable Fabric Article

(71) Applicant: Kayvan Hejazifar, Wilmington, OH (US)

(72) Inventor: Kayvan Hejazifar, Wilmington, OH (US)

(21) Appl. No.: 13/587,323

(22) Filed: Aug. 16, 2012

Related U.S. Application Data
(60) Provisional application No. 61/657,755, filed on Jun. 9, 2012.
(60) Provisional application No. 61/686,124, filed on Apr. 2, 2012.

(51) Int. Cl. B32B 3/10; A47G 9/02; B32B 5/02

(52) U.S. Cl. 428/58; 5/490; 5/495; 5/502; 5/482

(57) ABSTRACT

A separable fabric article includes first and second fabric portions each having at least one free edge. The separable fabric article includes a plurality of first magnetic fasteners spaced apart along the first portion free edge. Similarly, a plurality of second magnetic fasteners is spaced apart along the second portion free edge. The first and second fabric portions are movable between a connected configuration in which the plurality of first magnetic fasteners are coupled to the plurality of second magnetic fasteners and a released configuration in which the plurality of first magnetic fasteners are separated from the plurality of second magnetic fasteners. The free edges of the first and second portions are adjacent one another at the connected configuration and displaced from one another at the released configuration. Respective magnetic fasteners of said first and second fabric portions are configured to be in alignment at said connected configuration.

### CROSS REFERENCE TO RELATED APPLICATION

This non-provisional application claims the benefit of provisional patent application, 61/657,755 filed on Jun. 9, 2012 titled Linens and the Like Featuring Magnetic Fasteners which claims the benefit of provisional application 61/686,124, filed Apr. 2, 2012, titled Separable Bedding Featuring Magnetic Fasteners

### BACKGROUND OF THE INVENTION

This invention relates generally to segmented and separable fabrics and, more particularly, to a separable fabric article that may be repeatedly and selectively separated into at least two portions and rejoined into a single article by separating and reconnecting a plurality of spaced apart magnets, respectively.

Many couples sleep in separate rooms—not necessarily because of negative relations with their partner but rather due to other factors such as one partner may hog the covers, is consistently restless under the covers, gets up repeatedly throughout the night, or the partners have different temperature preferences. In this regard, couples often try sleeping with separate covers which, unfortunately, overlap one another and have an unsightly aesthetic appearance.

Various devices and proposals have been proposed in the art for segmented and separable bedding. For instance, U.S. Pat. No. 2,730,728 to Roberts describes a bed-cover partially divided into two sections which may be separated and re-united with such fasteners as zippers, snaps, buttons, and ribbons. In addition, U.S. Pat. No. 3,530,516 to Marquette describes a blanket constructed of two separate halves having different thicknesses with each half having one half of a slide-type fastener such as a zipper along each edge thereof to enable the blanket halves to be interchanged with one another or with similarly equipped blanket portions having different thicknesses. U.S. Pat. No. 4,005,499 to Klein discloses a bed covering, such as a blanket, sheet, or the like, having two separately washable and cleanable halves to be utilized independently and with tie means for removably connecting the parts together to form a complete assembly.

Although presumably effective for their intended purposes, the existing devices and proposals do not provide the easiest and most convenient structure for selectively separating and reuniting two or more fabric portions, such as bedding. Therefore, it would be desirable to have a separable fabric article having a plurality of magnetic fasteners that may be quickly and accurately connected or disconnected so as to separate or unite the fabric article. Further, it would be desirable to have a separable fabric article in which the magnetic fasteners are hidden from view so that the article appears to be a traditional fabric article when united.

### SUMMARY OF THE INVENTION

A separable fabric article according to the present invention includes first and second fabric portions each having at least one free edge. The separable fabric article includes a plurality of first magnetic fasteners spaced apart along the first fabric portion free edge. Similarly, a plurality of second magnetic fasteners is spaced apart along the second fabric portion free edge. The first and second fabric portions are selectively movable between a connected configuration in which the plurality of first magnetic fasteners are releasably coupled to the plurality of second magnetic fasteners and a released configuration in which the plurality of first magnetic fasteners are separated from the plurality of second magnetic fasteners. The free edges of the first and second fabric portion are configured to be adjacent one another at the connected configuration and displaced from one another at the released configuration. Respective magnetic fasteners of said first and second fabric portions are configured to be in alignment at said connected configuration.

Therefore, a general object of this invention is to provide a separable fabric article, such as a bed sheet, that may be used as a traditional single article when connected by magnetic fasteners or as two individual articles by disconnecting the magnetic fasteners.

Another object of this invention is to provide a separable fabric article, as aforesaid, that enables partners in a bed to use a portion of the fabric article independent of another portion of the fabric article in use by the other partner.

Still another object of this invention is to provide a separable fabric article, as aforesaid, that is easy and fast to separate into two portions and to re-unify into a single portion.

Yet another object of this invention is to provide a separable fabric article, as aforesaid, that may be completely or partially separated.

A further object of this invention is to provide a separable fabric article, as aforesaid, in which its fasteners are significantly hidden from view and appears to be a traditional fabric article when unified.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a separable fabric article according to a preferred embodiment of the present invention, shown in a unified configuration;

FIG. 2 is another perspective view of the separable fabric article as in FIG. 1, shown in a separated configuration;

FIG. 3a is a front view of the separable fabric article as in FIG. 1;

FIG. 3b is a sectional view of the separable fabric article taken along line 3b-3b of FIG. 3a;

FIG. 4 is a perspective view of the separable fabric article as in FIG. 2 with the hem removed to illustrate placement of magnetic fasteners; and

FIG. 5 is an isolated view on an enlarged scale of a magnetic disc.

### DESCRIPTION OF THE PREFERRED EMBODIMENT

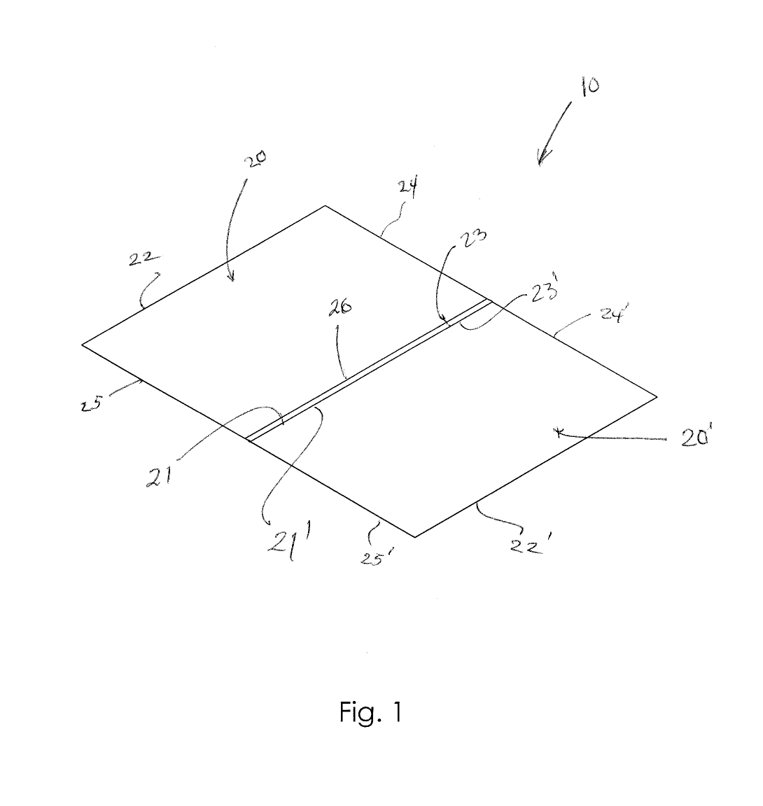

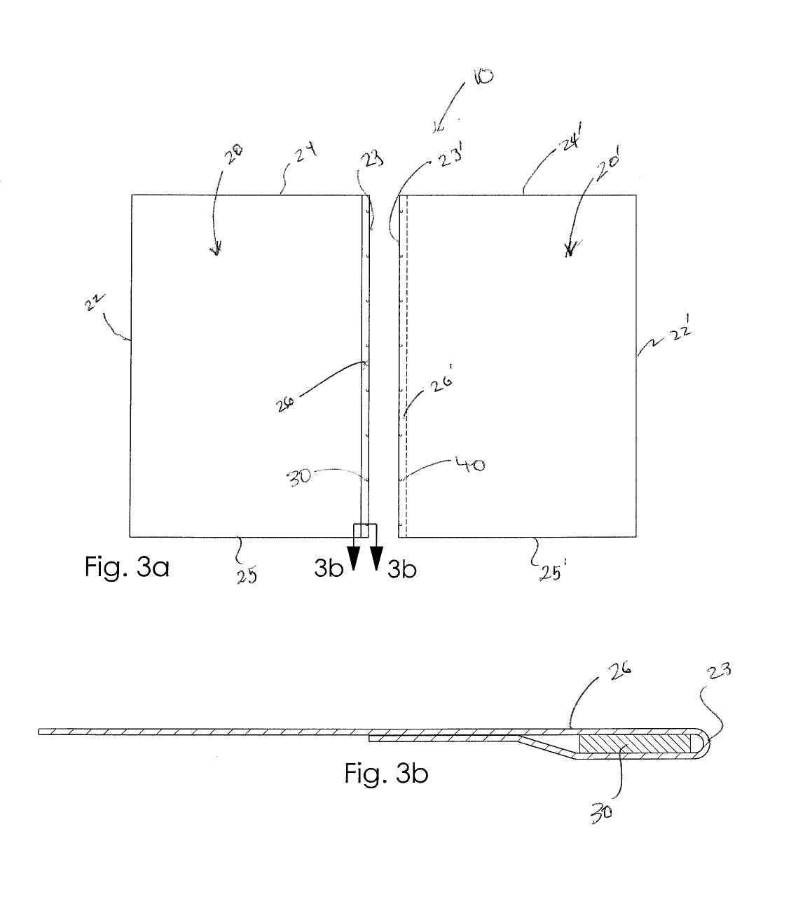

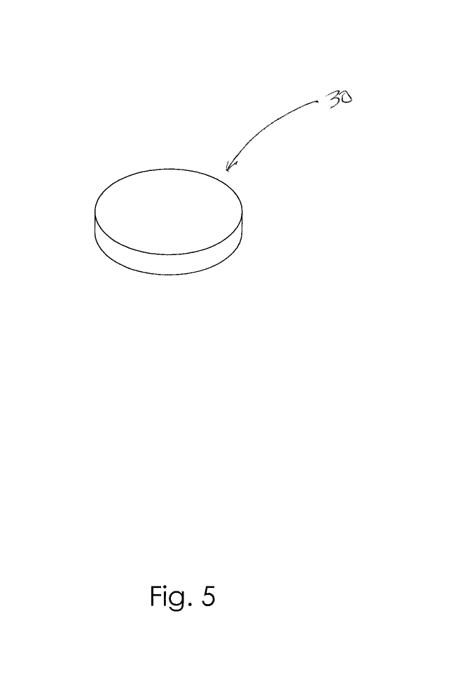

A separable fabric article according to a preferred embodiment of the present invention will now be described in detail with reference to FIGS. 1 to 5 of the accompanying drawings. The separable fabric article 10 includes a first fabric portion 20, a second fabric portion 20′, a plurality of first magnetic fasteners 30, and a plurality of second magnetic fasteners 40.

The first fabric portion 20 includes at least one free edge 21. In some embodiments, the first fabric portion 20 may include a peripheral configuration having multiple free edges, e.g. a sheet or blanket, while in other embodiments, there may only be two free edges, e.g. a pillow case. For instance, the figures illustrate an embodiment in which the fabric article is an article of bedding, such as a sheet, blanket, comforter, or the like. In this embodiment, a first fabric portion 20 and a second fabric portion 20′ each includes respective free edges 21, 21′ with respective free edges aligned adjacent one another in the figures.

More particularly, the first fabric portion 20 in some embodiments includes a first portion outer longitudinal edge 22 and an opposed inner longitudinal edge 23, the inner and outer longitudinal edges having the same length. For the purpose of the present invention, it should be observed that the inner longitudinal edge 23 is also the free edge 21. Opposed first portion top 24 and bottom 25 edges may extend between first portion outer 22 and inner 23 longitudinal edges. In this embodiment, the first fabric portion 20 defines a fabric article such as a sheet, blanket, comforter, or the like. The second fabric portion 20′ includes a construction substantially similar to that of the first fabric portion 20 and primed numerals are used to reference like structures. The top free edge defines the width of each fabric portion. Preferably, the width of the top edge of the first fabric portion 20 is the same as the width of the second fabric portion 20′ and together they define the width of the united separable fabric article 10.

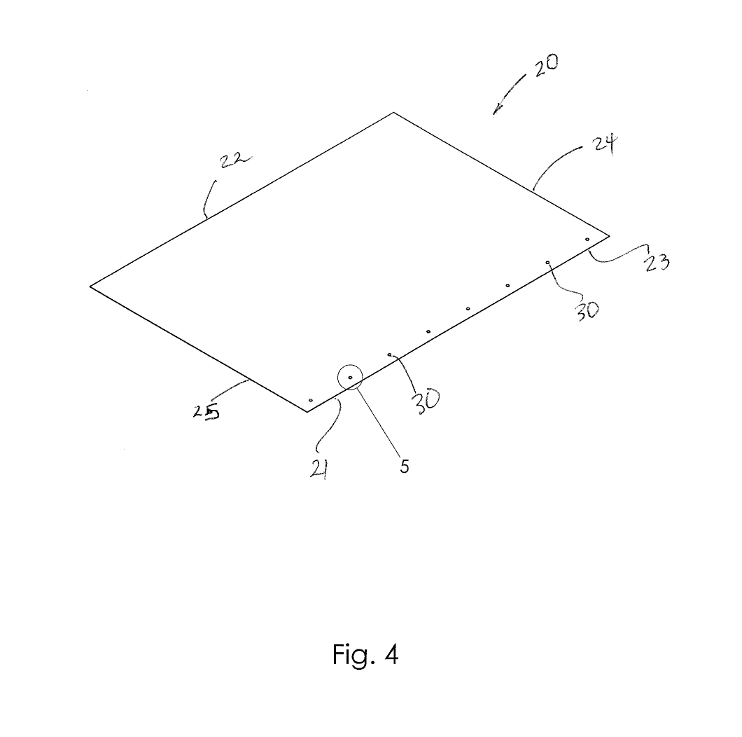

With further reference to the embodiment illustrated in the figures, the plurality of first magnetic fasteners 30 is spaced apart along the first fabric portion free edge (FIG. 4). Similarly, the plurality of second magnetic fasteners 40 is spaced apart along the second fabric portion free edge (FIG. 4). As described in detail above, the edge adjacent which the plurality of first magnetic fasteners 30 is positioned is the first portion inner longitudinal edge 23 and the edge adjacent which the plurality of second magnetic fasteners 40 is positioned is the second portion inner longitudinal edge 23′.

It is understood that both the plurality of first magnetic fasteners 30 and the plurality of second magnetic fasteners 40 may be magnets having opposite polarity. Alternatively, the plurality of first magnetic fasteners 30 may be actual magnets and the plurality of second magnetic fasteners 40 may be constructed of a metal that is attracted to the magnets.

Preferably, the magnetic fasteners are thin disc magnets, each magnetic fastener may have a square, rectangular, or any other shape or construction that is consistent with this disclosure.

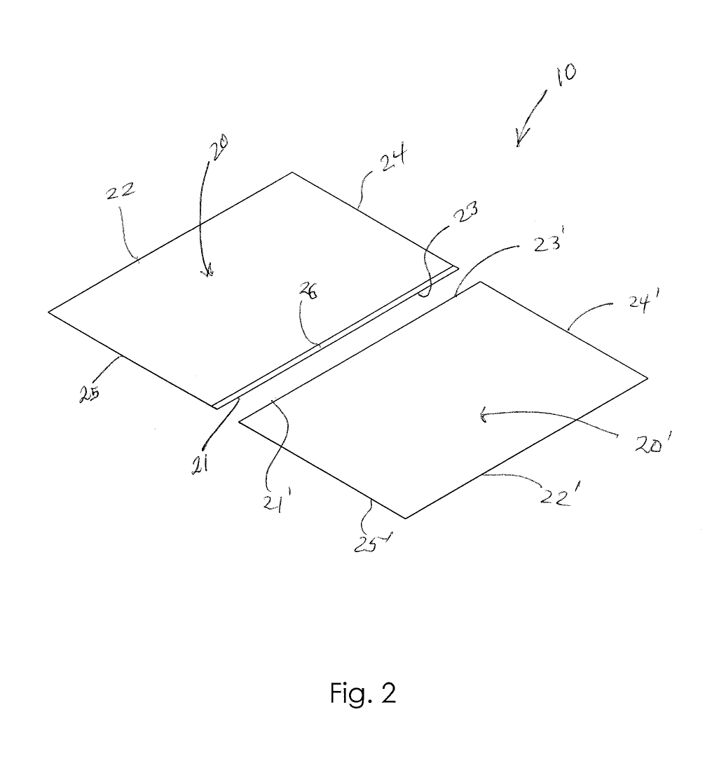

Preferably, the first 21 and second 21′ fabric portion free edges include a first 26 and second 26′ hemmed edges, respectively (FIG. 2). The hemmed edges may be generally adjacent respective inner longitudinal edges of respective first and second fabric portions and may be displaced about one inch therefrom. Preferably, respective magnetic fasteners are positioned within the respective hemmed interior area so that a user is never in actual physical contact with the magnetic fasteners. The hemmed areas also envelop respective magnetic fasteners so as to protect them while the fabric article is being laundered.

It is understood that respective magnetic fasteners positioned on the first fabric portion 20 are aligned with associated magnetic fasteners on the second fabric portion 20′.

Preferably, the magnetic fasteners of the first fabric portion 20 have a substantially similar configuration so that they engage efficiently with one another.

The first 20 and second 20′ fabric portions are selectively movable between a connected configuration in which the plurality of first magnetic fasteners 30 are releasably coupled to the plurality of second magnetic fasteners 40 (FIG. 1) and a released configuration in which the plurality of first magnetic fasteners 30 are separated from the plurality of second magnetic fasteners 40 (FIG. 2). The fabric portions may be aligned, such as shown in FIG. 1, and then the respective magnetic fasteners will automatically engage one another. The unified fabric portions may be separated by gently overcoming the magnetic attraction between engaged magnetic fasteners as will be further described later. The inner longitudinal free edges 23, 23′ of the first 20 and second 20′ portions are adjacent one another at the connected configuration and are displaced from one another at the released configuration. More particularly, the inner longitudinal edges may overlap one another when the respective fasteners are connected.

In another embodiment, one of the magnetic fasteners, such as one adjacent a respective fabric portion bottom edge, may be stronger than the remaining magnets such that it remains coupled to a corresponding magnet from the other fabric portion until a stronger overcoming force is applied to it. It is understood that the stronger magnet (which may be referred to as an “ alignment magnet” (not shown) may be useful to keep the bottom edge of the first 20 and second 20′ fabric portions connected and aligned even when all or part of the remaining magnetic fasteners are separated. With respective alignment magnets engaged, it will be easier for a user to move otherwise separated fabric portions to the connected configuration.

In use, a separable fabric article 10, such as a bed sheet, may be situated and configured upon a bed in a traditional manner and such that it is nearly imperceptible that the article is anything other than a traditional bed sheet. More particularly, the first 20 and second 20′ fabric portions may be manipulated to the connected configuration in which aligned and corresponding first magnetic fasteners 30 are releasably connected to corresponding second magnetic fasteners 40. Subsequently, the first 20 and second 20′ fabric portions may be moved to the released or disconnected configuration by gently pulling corresponding connecting magnetic fasteners away from one another. It is possible to make this separation even after partners in the bed have already taken up positions under the unified fabric article but then desire to have the independence to manipulate his or her portion without any involvement or interference by the other partner.

The separable fabric article 10 shown and described may be a bedding article, such as a sheet, blanket, comforter, quilt, duvet, or the like. In other embodiments, however, the first 20 and second 20′ fabric portions may be first and second panels of a pillow case (not shown). In still other embodiments, the first and second fabric portions may be united to form a furniture covering (indoor or outdoor). Further, first and second fabric portions may include towels having free edges and respective spaced apart magnets such that two or more towels may be connected to form a large beach towel, it being understood that alternative magnet placements may be possible other than merely along adjacent inner longitudinal edges (e.g. such as in the corners).

It is understood that while certain forms of this invention have been illustrated and described, it is not limited thereto except insofar as such limitations are included in the following claims and allowable functional equivalents thereof.

1. A separable fabric article, comprising:
a first fabric portion;
a second fabric portion;
a plurality of first magnetic fasteners positioned on said first fabric portion a plurality of second magnetic fasteners positioned on said second fabric portion;
wherein said first and second fabric portions are selectively movable between a connected configuration in which said plurality of first magnetic fasteners are releasably coupled to said plurality of second magnetic fasteners and a released configuration in which said plurality of first magnetic fasteners are separated from said plurality of second magnetic fasteners; and
wherein said first fabric portion is adjacent said second fabric portion at said connected configuration and first fabric portion is displaced from said second fabric portion at said released configuration.

2. The separable fabric article as in claim 1, wherein:
said first fabric portion includes at least one free edge and said first plurality of magnetic fasteners are spaced apart along said first fabric portion free edge;
said second fabric portion includes at least one free edge and said second plurality of magnetic fasteners is spaced apart along said second fabric portion free edge;
said first fabric portion free edge includes a first hemmed edge;
said plurality of first magnetic fasteners are situated within said first hemmed edge;
said second fabric portion free edge includes a second hemmed edge; and
said plurality of second magnetic fasteners are situated within said second hemmed edge.

3. The separable fabric article as in claim 2, wherein:
said plurality of first magnetic fasteners are magnets; and
said plurality of second magnetic fasteners are metal elements.

4. The separable fabric article as in claim 1, wherein:
each one of said plurality of first magnetic fasteners is the same size as each one of said plurality of second magnetic fasteners; and
a respective one of said plurality of first magnetic fasteners is aligned with a respective one of said plurality of second fasteners.

5. The separable fabric article as in claim 1, wherein said plurality of first magnetic fasteners are taken from the group including disc magnets, square magnets, and rectangular magnets.

6. The separable fabric article as in claim 1, wherein:
said first fabric portion includes a first portion outer longitudinal edge and an opposed first portion inner longitudinal edge opposite said first portion outer longitudinal edge;
said plurality of first magnetic fasteners being situated adjacent said first portion inner longitudinal edge;
said second fabric portion includes a second portion outer longitudinal edge and an opposed second portion inner longitudinal edge opposite said second portion outer longitudinal edge; and
said plurality of second magnetic fasteners being situated adjacent said second portion inner longitudinal edge.

5. The separable fabric article as in claim 6, wherein:
said first fabric portion includes a first portion top edge extending between said first portion outer longitudinal edge and said first portion inner longitudinal edge;
said first fabric portion includes a first portion bottom edge extending between said first portion outer longitudinal edge and said first portion inner longitudinal edge, said first portion top edge being opposite said first portion bottom edge;
said second fabric portion includes a second portion top edge extending between said second portion outer longitudinal edge and said second portion inner longitudinal edge; and
said second fabric portion includes a second portion bottom edge extending between said second portion outer longitudinal edge and said second portion inner longitudinal edge, said second portion top edge being opposite said second portion bottom edge.

6. The separable fabric article as in claim 7, wherein:
said first portion top edge defines a width equal to a width of said first portion bottom edge;
said second portion top edge defines a width equal to a width of said second portion bottom edge;
said first portion top edge width is equal to said second portion top edge width; and
said first portion and said second portion form a bed sheet when situated at said connected configuration.

7. The separable fabric article as in claim 6, wherein said first fabric portion is a first towel and said second fabric portion is a second towel.

10. The separable fabric article as in claim 1, wherein said first fabric portion is one panel of a pillow case and said second fabric portion is a second panel of said pillow case.

11. The separable fabric article as in claim 1, wherein said first fabric portion and said second fabric portion are taken from the group comprising sheets, comforters, blankets, bedding, and furniture coverings.

12. The separable fabric article as in claim 2, wherein:
said plurality of first magnets is displaced about one inch from said at least one free edge of said first fabric portion; and
said plurality of second magnets is displaced about one inch from said at least one free edge of said second fabric portion.

13. The separable fabric article as in claim 12, wherein said first fabric portion free edge overlaps said second fabric portion free edge at said connected configuration and first fabric portion free edge is displaced from said second fabric portion free edge at said released configuration.
